(19) United States
(12) Patent Application Publication
(10) Pub. No.: US 2024/0428058 A1
(43) Pub. Date: Dec. 26, 2024

(54) HARDWARE-BASED NEURAL NETWORK AND METHOD OF TRAINING

(71) Applicant: Cyberswarm, Inc., San Mateo, CA (US)

(72) Inventors: Andrei ILIESCU, Ploiesti (RO); Elena-Adelina DUCA, Ploiesti (RO); Viorel-Georgel DUMITRU, Ploiesti (RO)

(73) Assignee: Cyberswarm, Inc., San Mateo, CA (US)

(21) Appl. No.: 18/340,552

(22) Filed: Jun. 23, 2023

(51) Int. Cl. G06N 3/063

(52) U.S. Cl. CPC G06N 3/063

(57) ABSTRACT

A hardware based neural network may include a plurality of layers of artificial neurons with electronically adjusted activation function thresholds and a plurality of memristors providing weighted connections between the plurality of layers. The activation function thresholds and the weighted connections may be configured adjusted during a training of the hardware based neural network.

### CROSS REFERENCE TO RELATED APPLICATIONS

This application is related to U.S. Pat. No. 10,902,914, entitled “Programmable resistive memory element and a method of making the same,” filed Jun. 4, 2019, and issued Jan. 26, 2021, which is hereby incorporated by reference in its entirety. This application is also related to U.S. Pat. No. 11,183,240, entitled “Programmable resistive memory element and a method of making the same,” filed Jan. 26, 2021, and issued Nov. 23, 2021, which is also hereby incorporated by reference in its entirety. This application is also related to U.S. patent application Ser. No. 18/048,594, entitled “Analog programmable resistive memory,” filed Oct. 21, 2022, which is also hereby incorporated by reference in its entirety.

### BACKGROUND

Hardware-based neural networks are very promising to overcome the problems associated with increasing energy consumption and computation power needed in software-based neural networks. However, the training of the hardware-based neural networks is done usually using the backpropagation algorithm relying on software for computing the gradient of the loss function with regards to the weights. This is, however, complicated, and needs a lot of time, energy, and computing power. Furthermore, this type of training requires the knowledge of every weight and specification of neuron activation function from the network with high accuracy.

### SUMMARY

Embodiments disclosed herein solve the aforementioned technical problems and may provide other technical solutions as well. A hardware-based neural network and a method of training there are disclosed. The hardware-based neural network may Include memristors acting as network weights and artificial neurons with adjustable thresholds built with electronic components. The method for supervised offline in-situ learning of the hardware-based neural network may determine the relevance of each neuron for the network output and may adjust accordingly the weights connections of that neuron. The relevance of each neuron is determined by modifying its parameters through a potentiometer or a variable resistor.

In an embodiment, a hardware-based neural network is provided. The hardware based neural network may include a plurality of layers of artificial neurons with electronically adjustable activation function thresholds and a plurality of memristors providing weighted connections between the plurality of layers. The activation function thresholds and the weighted connections may be adjusted during a training of the hardware based neural network.

In another embodiment, method of training a hardware-based neural network may be provided. The method may include inputting, to the hardware-based neural network, a sequence of inputs corresponding to a pattern to be recognized, the hardware-based neural network comprising a plurality of layers formed by artificial neurons having electronic components for providing activation functions and a plurality of memristors providing weighted connections between the plurality of layers. The method may also include adjusting corresponding activation function thresholds for a plurality artificial neurons in the hardware-based neural network, the adjusting being based on an output of an output layer, and the adjusting beginning from the output layer and going backward toward an input layer. The method may further include modifying resistances of the plurality of memristors based on the adjusted corresponding activation function thresholds.

### BRIEF DESCRIPTION OF THE DRAWINGS

FIG. 1 shows an example hardware-based neural network based on the principles disclosed herein.

FIG. 2 shows a detailed view of two adjacent layers of the hardware-based neural network shown in FIG. 1, based on the principles disclosed herein.

FIG. 3 shows an example artificial neuron with an adjustable threshold built with electronic components, based on the principles disclosed herein.

FIG. 4 shows an example method of training the hardware-based neural network shown in FIG. 1, based on the principles disclosed herein.

### DETAILED DESCRIPTION

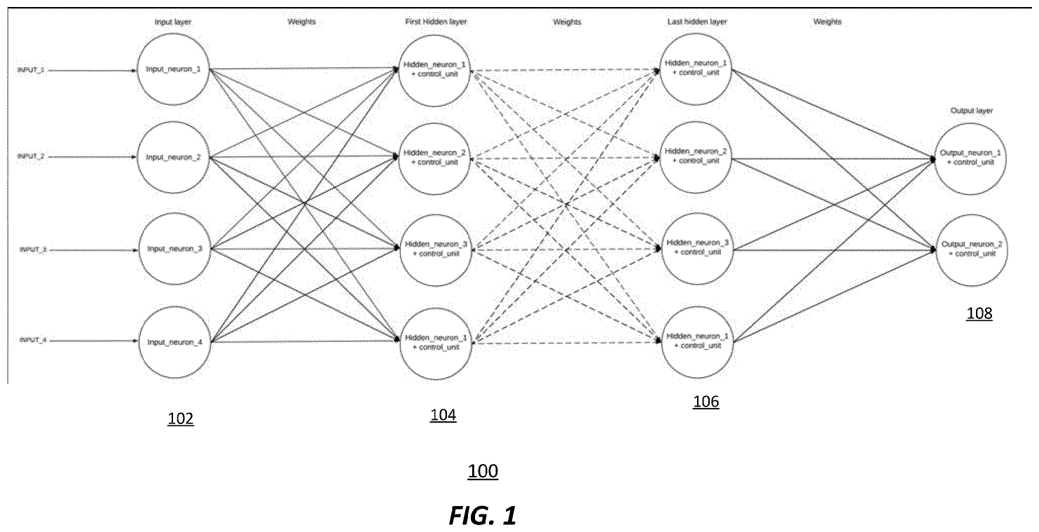

FIG. 1 shows an example hardware-based neural network 100 based on the principles disclosed herein. In the shown example, the hardware-based neural network 100 has four input neurons 102, four hidden layers neurons 104, four hidden layer neurons 106, and two output neurons 108. It should, however, be understood that this is just an example and hardware-based neural networks with more neurons in the input, output, and hidden layers built with different types of activation functions (e.g., sigmoid, linear, hyperbolic, tangent, or step-like) should be considered within the scope of this disclosure. As further described below, the hardware-based neural network 100 may include memristors as network weights and artificial neurons with adjustable thresholds built with electronic components (e.g., transistors, diodes, logic gates, operational amplifiers).

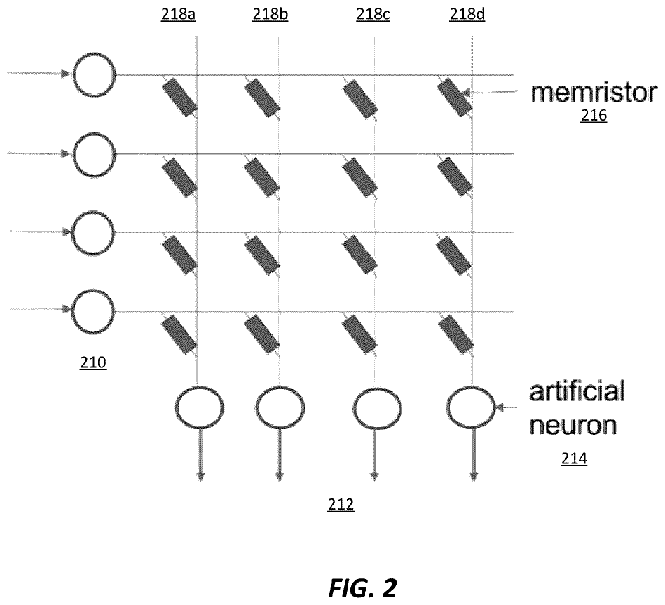

FIG. 2 shows a detailed view of two adjacent layers 210, 212 of the hardware-based neural network 100 shown in FIG. 1, based on the principles disclosed herein. Particularly, the adjacent layers 210, 212 may include artificial neurons 214 connected by memristors 216. As shown, the artificial neurons 214 may form any one of the input neurons 102, hidden layer neurons 104, 106, or output neurons 108 in the hardware based neural network 100. In one or more embodiments, the memristors 216 may be arranged in crossbar configuration on a same plane, as shown. The crossbar configuration may include multiple columns 218a-218d, commonly referred to as a column 218. The memristors 216 may act as network weights. Different types of memristors 216 could be employed for hardware-based neural network 100. For instance, Indium gallium zinc oxide (IGZO) memristors 216 with coplanar electrodes as disclosed in U.S. Pat. Nos. 10,902,914 and 11,183,240 and U.S. patent application Ser. No. 18/048,594 may be used. All of these references have been incorporated by references in their entireties. It should, however, be understood that the shown crossbar combination is just an example, and any kind of configuration that connects the memristors 216 to the artificial neurons 214 should be considered within the scope of this disclosure.

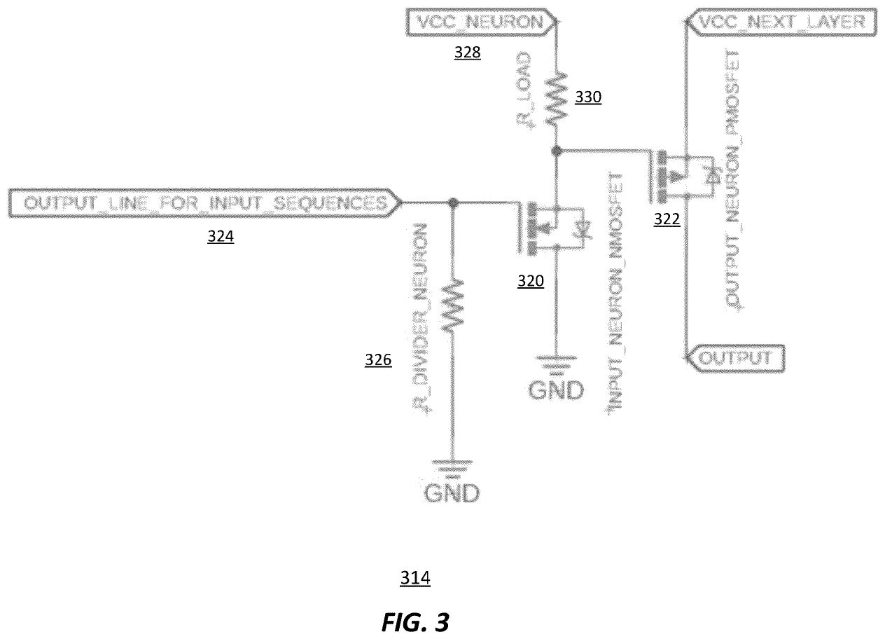

FIG. 3 shows an example of an artificial neuron 314 with an adjustable threshold built with electronic components, based on the principles disclosed herein. The artificial neuron 314 may be similar to the artificial neuron 214 shown in FIG. 2. That is, the artificial neuron 314 may be used as input neurons 102, output neurons 108, or hidden layer neurons 104, 106. As shown, the artificial neuron 314 may include a set of complementary MOSFETs, NMOSFET 320 (generally, a n-type transistor) and PMOSFET 322 (generally, a p-type transistor).

An output line 324 of a memristor column 218 of the crossbar that processes the input sequences may come from a previous layer in the hardware-based neural network 100. The output line 324 may be connected to the ground via a potentiometer (R_DIVIDER_NEURON) 326. The potentiometer 326 may create a voltage divider that may act as a variable in the threshold activation function for the NMOSFET 320. When the threshold voltage is achieved, the NMOSFET 320 may enter the linearity mode which may let the current from VCC_NEURON 328 (supplying positive voltage) pass through the R_LOAD 330 and NMOSFET 320 (generated from the Ohmic Region of the NMOSFET 320) to the ground, resulting in a voltage drop on both R_LOAD 330 and NMOSFET 320. This way there may be created a second voltage divider in which the voltage is supplied to the PMOSFET 322.

It is to be understood the shown electronic components of the neuron are just examples, and any kind of electronic components should be considered within the scope of this disclosure. For instance, as an alternate to the potentiometer 326, a variable resistance or a second, different memristor may be used. As alternates to the MOSFETS 320, 322; other electronic switching devices may be used. The other electronic switching devices may include, but are not limited to, a diode, an operational amplifier, a logic gate, and/or any other type of electronic switching device. In one or more embodiments, a combination of different switching devices may be used. For example, other switching devices may be used in combination with the MOSFETs 320, 322.

Furthermore, the activation function of the neuron 314 may be of any shape. Some non-limiting examples of the activation function include hyperbolic, sigmoid, step-like, linear, tangent, and/or any kind of shape known in the art.

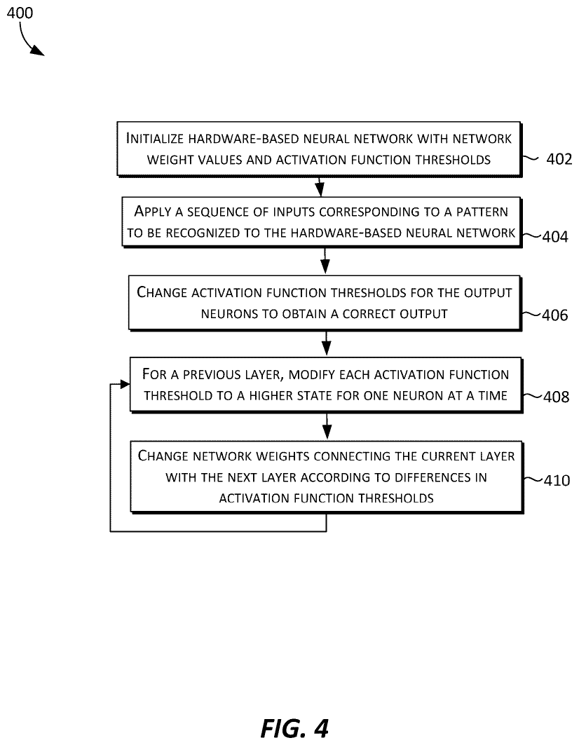

FIG. 4 shows an example method 400 of training the hardware-based neural network shown in FIG. 1, based on the principles disclosed herein. The steps of the method 400 are merely examples and methods with additional, alternate, or fewer number of steps should be considered within the scope of this disclosure.

The method 400 may begin at step 402, where a hardware-based neural network may be initialized. The initialized hardware-based neural network may include network weights having same or different values (e.g., given by the resistances of fabricated memristors 216 shown in FIG. 2). Additionally, the initialized hardware-based neural network may have different activation function thresholds of activation for neurons (e.g., as determined by corresponding potentiometers).

At step 404, a sequence of inputs corresponding to the pattern to be recognized may be applied to the hardware-based neural network. That is, the hardware-based neural network may be trained to recognize the pattern using the method 400.

At step 406, activation function thresholds for the output neurons may be changed to obtain the correct output for the respective input pattern. The activation function thresholds may be changed by increasing corresponding threshold values (e.g., for the corresponding potentiometers) for all the neurons from the output layer except the one corresponding to the correct output. For the other neurons not corresponding to the correct output, the changed activation function threshold may be based on the difference between an observed output and the correct output.

At step 408, for a previous layer, each activation function threshold (e.g., threshold value for corresponding potentiometer) may be modified to a higher state for one neuron at a time. The activation function threshold modification may be performed by determining the difference in activation function threshold that may be needed to be applied for that neuron to influence the output. The difference in the activation function threshold may be stored in a memory, afterward, the activation function threshold may be changed to its previous state. Step 408 may be executed for every neuron in that layer.

At step 410, the network weights connecting the current layer with the next layer are changed according to the differences in activation function thresholds determined in step 408 In this way, neurons that influence the output the least may become weaker connections with the next layer (i.e., resistances of the corresponding memristors will be increased). The neurons that influence the output the most may get a stronger connection with the next layer (i.e., resistances of the corresponding memristors will be left unchanged or decreased). Changing the memristors resistance could be done in various ways, depending also on the types of memristors employed. For instance, in the case of IGZO memristors with coplanar electrodes described in U.S. Pat. Nos. 10,902,914 and 11,183,240 and patent application Ser. No. 18/048,594, the resistance change could be performed by applying voltage signals, e.g., voltage sweeps with different voltage upper limits based on the desired resistance state, or one or more voltage pulses with the same amplitude or with increasing amplitudes, etc.

Steps 408 and 410 may be repeated for all the layers present in the hardware-based neural network 100, until a desired level of accuracy is reached.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. A hardware-based neural network comprising:
a plurality of layers of artificial neurons with electronically adjusted activation function thresholds;
a plurality of memristors providing weighted connections between the plurality of layers; and
the activation function thresholds and the weighted connections being adjusted during a training of the hardware-based neural network.

2. The hardware-based neural network of claim 1, the memristors comprising Indium gallium zinc oxide (IGZO)-based memristors.

3. The hardware-based neural network of claim 1, the memristors having electrodes situated on a same plane.

4. The hardware-based neural network of claim 1, each artificial neuron comprising at least one of a potentiometer, a variable resistance, or a second memristor that is used for electronically adjusting corresponding activation function threshold.

5. The hardware-based neural network of claim 4, at least one of the potentiometer, the variable resistance, or the second memristor operating as a voltage divider to configure the corresponding threshold.

6. The hardware-based neural network of claim 1, each artificial neuron comprising one or more electronic components.

7. The hardware-based neural network of claim 6, the one or more electronic components comprising at least one of an n-type transistor, a p-type transistor, a diode, an operational amplifier, or a logic gate.

8. The hardware-based neural network of claim 6, at least one of the one or more electronic components being configured to start conducting current when a corresponding activation function threshold is reached.

9. The hardware-based neural network of claim 6, at least one of the one or more electronic components being configured to provide an output to a next layer.

10. The hardware-based neural network of claim 1, each artificial neuron having a activation function comprising at least one of a sigmoid function, linear function, hyperbolic function, tangent function, or step-like function.

11. A method of training a hardware-based neural network, the method comprising:
inputting, to the hardware-based neural network, a sequence of inputs corresponding to a pattern to be recognized, the hardware-based neural network comprising:
a plurality of layers formed by artificial neurons having electronic components for providing activation functions, and
a plurality of memristors providing weighted connections between the plurality of layers;
adjusting corresponding activation function thresholds for the artificial neurons in the hardware-based neural network, the adjusting being based on an output of an output layer, and the adjusting beginning from the output layer and going backward toward an input layer; and
modifying resistances of the plurality of memristors based on the adjusted corresponding activation function thresholds.

12. The method of claim 11, the each artificial neuron comprising at least one of a potentiometer, a variable resistance, or a second memristor,
the adjusting the corresponding activation function comprising:
changing a resistance of the at least one of the potentiometer, the variable resistance, or the second memristor.

13. The method of claim 12, at least one of the potentiometer, the variable resistance, or the second memristor operating as a voltage divider to adjust the corresponding activation function threshold.

14. The method of claim 11, the activation functions comprising at least one of a sigmoid function, linear function, hyperbolic function, tangent function, or step-like function.

15. The method of claim 11, the plurality of memristors comprising Indium gallium zinc oxide (IGZO)-based memristors.

16. The method of claim 15, the modifying the resistances of the plurality of memristors comprising:
applying voltage signals with different voltage upper limits, amplitudes, and/or durations to the plurality of memristors.

17. The method of claim 11, each of the plurality of artificial neurons comprising one or more electronic components.

18. The method of claim 17, the electronic components comprising at least one of an n-type transistor, a p-type transistor, a diode, an operational amplifier, or a logic gate.

19. The method of claim 17, at least one of the electronic components starts to conduct current when a corresponding threshold is reached.

20. The method of claim 17, at least one of the electronic components provides an output to a next layer.
